(19) United States
(12) Patent Application Publication
(10) Pub. No.: US 2026/0233329 A1
(43) Pub. Date: Aug. 13, 2026

(54) WELDING APPARATUS AND METHOD OF OPERATION THEREOF

(71) Applicant: SK On Co., Ltd., Seoul (KR)

(72) Inventors: Min Jeong HONG, Daejeon (KR); Oh San AN, Daejeon (KR); Ji Yoon YOUM, Daejeon (KR); Seul Gi LEE, Daejeon (KR); Deok Min JEON, Daejeon (KR)

(21) Appl. No.: 19/531,674

(22) Filed: Feb. 6, 2026

(30) Foreign Application Priority Data
Feb. 11, 2025 (KR) 10-2025-0017103

(51) Int. Cl. B23K 26/03; B23K 26/042; B23K 26/064

(52) U.S. Cl. CPC B23K 26/032; B23K 26/043; B23K 26/0643

(57) ABSTRACT

The present disclosure relates to a welding apparatus and a method of operation thereof. A welding apparatus according to an embodiment of the present disclosure may comprise a stage on which an object to be welded is positioned, a laser for irradiating light onto the object to weld, a camera for obtaining an image of the object, and a controller for controlling the camera, wherein the controller may check a state of the object, control the camera to obtain the image by adjusting a setting of the camera to preset setting corresponding to the state of the object, and inspect the object using the image.

### CROSS-REFERENCE TO RELATED PATENT APPLICATION

The present application claims priority under 35 U.S.C. § 119a to Korean patent application number 10-2025-0017103 filed on February 11, 2025, in the Korean Intellectual Property Office, the entire disclosure of which is incorporated by reference herein.

### BACKGROUND OF THE DISCLOSURE

### Field

The present disclosure relates to a welding apparatus and a method of operation thereof. More particularly, it relates to a welding apparatus for a secondary battery and a method of operation thereof.

### Description of the Related Art

A manufacturing process for a secondary battery may include a laser welding process for joining a plurality of structures together.

In order to perform welding by accurately specifying a target area to be welded, a camera is placed on the outside of the welding apparatus, and a method of photographing the target area through the camera is used.

However, the image of the target area taken by the externally disposed camera is affected by light reflection and shadows, and the resolution is low, resulting in low accuracy of laser welding.

Therefore, in a laser welding process, it is necessary to increase the yield of the process by accurately specifying the target area to be welded and proceeding with welding.

According to one aspect of the present disclosure, an object is to improve the manufacturing cost of battery cells.

According to another aspect of the present disclosure, an object is to improve the manufacturing time of battery cells.

According to another aspect of the present disclosure, an object is to improve the quality of an image.

According to another aspect of the present disclosure, an object is to improve the quality of welding.

The present disclosure can be widely applied in the field of green technology, such as electric vehicles, battery charging stations, energy storage systems, photovoltaics, wind power, and other fields that utilize battery cells. The present disclosure can also be used in eco-friendly mobility, including electric and hybrid vehicles to prevent climate change by reducing air pollution and greenhouse gas emissions.

### SUMMARY OF THE DISCLOSURE

A welding apparatus according to an embodiment of the present disclosure may comprise a stage on which an object to be welded is positioned, a laser for irradiating light onto the object to weld, a camera for obtaining an image of the object, and a controller for controlling the camera, wherein the controller may check a state of the object, control the camera to obtain the image by adjusting a setting of the camera to preset setting corresponding to the state of the object, and inspect the object using the image.

According to an embodiment, the preset setting may include any one or a combination of a preset exposure value, a preset frame per second, a preset sensitivity value based on the international organization for standardization, and a preset field of view.

According to an embodiment, the state of the object may include a state prior to welding being performed using the laser.

According to an embodiment, the controller may determine a welding path of the laser using the image obtained with the preset setting corresponding to the state prior to welding being performed when the state is a state prior to welding being performed, and controls the laser to move along the welding path.

According to an embodiment, the laser may include a light source to output the light and a scanner to adjust the path of the light.

According to an embodiment, the controller may control the scanner so that the light output from the light source moves along the welding path and is irradiated onto the object.

According to an embodiment, the welding apparatus may further comprise a plurality of reflective members for directing the light output from the light source and reflected light reflected from the object to the scanner.

According to an embodiment, the plurality of reflective members may include a first reflective member for reflecting the light output from the light source and transmitting the reflected light, and a second reflective member for reflecting the reflected light transmitted through the first reflective member.

According to an embodiment, the optical axis of the light irradiated from the laser onto the object and the optical axis of the reflected light incident on the camera may be coaxial.

According to an embodiment, the state of the object may further include a state in which welding is in progress using the laser.

According to an embodiment, the controller may adjust a shooting area of the camera to a preset shooting area of the camera corresponding to the state in which welding is in progress when the state of the object is a state in which welding is in progress, and the area of the preset shooting area corresponding to the state in which welding is in progress may be smaller than an area of the camera's preset shooting area corresponding to the state prior to welding being performed.

According to an embodiment, the state of the object may further include a state in which welding is complete using the laser.

According to an embodiment, the controller may adjust a shooting area of the camera to a preset shooting area of the camera corresponding to the state in which welding is complete when the state of the object is a state in which welding is complete, and the area of the preset shooting area corresponding to the state in which welding is complete may be larger than an area of the camera's preset shooting area corresponding to the state in which welding is in progress.

According to an embodiment, the controller may use the image obtained with the preset setting corresponding to the state in which welding is complete to inspect whether the object is defective when the state of the object is the state in which welding is complete.

A method of operation of a welding apparatus, including a stage on which an object to be welded is positioned, a laser for irradiating light onto the object to weld, and a camera for obtaining an image of the object, according to another embodiment of the present disclosure may comprise a step of positioning the object on the stage, a step of checking a state of the object, a step of controlling the camera to the preset setting corresponding to the state of the object, a step of obtaining an image for the object using the camera, and a step of inspecting the object using the image.

### BRIEF DESCRIPTION OF THE DRAWINGS

FIG. 1 is a schematic block diagram of a welding apparatus according to the present disclosure.

FIG. 2 is a diagram illustrating a welding apparatus according to the present disclosure.

FIG. 3 is a flow diagram illustrating a method for inspecting an object using a welding apparatus according to the present disclosure.

FIG. 4 is a flow diagram illustrating a method for determining a welding path when a state of an object according to the present disclosure is a state prior to welding being performed.

FIG. 5 is a diagram illustrating a method for determining a welding path when a state of an object according to the present disclosure is a state prior to welding being performed.

FIG. 6 is a flow diagram illustrating a method for performing a welding when a state of an object according to the present disclosure is a state in which welding is in progress.

FIG. 7 is a diagram illustrating a method for performing a welding when a state of an object according to the present disclosure is a state in which welding is in progress.

FIG. 8 is a flow diagram illustrating a method for inspecting an object when a state of an object according to the present disclosure is a state in which welding is complete.

FIG. 9 is a diagram illustrate a method for inspecting an object when a state of an object according to the present disclosure is a state in which welding is complete.

FIG. 10 is a diagram illustrating how a welding apparatus according to the present disclosure inspects an object.

### DETAILED DESCRIPTION

Certain terms used in this specification are for convenience of description only and are not intended to limit the embodiments shown.

For example, expressions such as "identical" and "identical" not only indicate a state of being strictly identical, but also indicate a state of being with tolerances or differences in the degree to which the same function is obtained.

For example, expressions such as "in a direction", "along a direction", "side by side", "perpendicular", "central", "concentric" or "coaxial", which indicate a relative or absolute arrangement, not only strictly indicate such an arrangement, but also indicate a state of relative displacement with a tolerance, or an angle or distance such that the same function is obtained.

The use of terms such as "first, second, third," etc., preceding the components referred to herein is intended to avoid confusion as to the components to which they refer, and is not intended to indicate the order, importance, or master-servant relationship between the components. For example, it is possible to implement an invention comprising only the second component without the first component.

As used herein, the singular expression may include the plural unless the context clearly indicates otherwise.

Preferred embodiments of the present disclosure will be described in detail below with reference to the accompanying drawings. The apparatus configurations and control methods described herein are for the purpose of illustrating embodiments of the present disclosure and are not intended to limit the scope of the disclosure, and like reference numerals used throughout the description refer to like components.

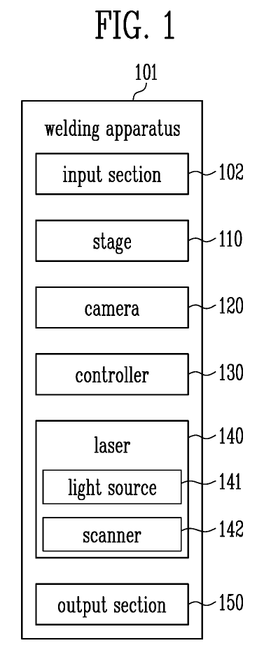

FIG. 1 is a schematic block diagram of a welding apparatus according to the present disclosure.

Referring to FIG. 1, a welding apparatus 101 according to the present disclosure may include an input 102, a stage 110, a camera 120, a controller 130, a laser 140, and an output section 150.

For example, the welding apparatus 101 may represent an apparatus for welding an object to be welded. For example, the welding apparatus 101 may represent an apparatus for determining a welding path of the laser 140 to the object when the state of the object is a state prior to welding being performed. For example, the welding apparatus 101 may represent an apparatus for inspecting the object when welding being performed or welding is complete.

For example, the welding apparatus 101 may represent an apparatus for welding an object to a secondary battery. The object may be included in a member included in the secondary battery.

For example, the controller 130 may control the overall operation of the welding apparatus 101. For example, the controller 130 may control the camera 120 and the laser 140. For example, the controller 130 is shown in a member included in the welding apparatus 101 shown in FIG. 1, but may be implemented as a device independent of the welding apparatus 101.

In an embodiment, a welding apparatus 101 may comprise a stage 110 on which an object to be welded is positioned, a laser 140 for irradiating light onto the object to weld, a camera 120 for obtaining an image of the object, and a controller 130 for controlling the camera 120. Further, the controller 130 may check a state of the object, may control the camera 120 to obtain the image by adjusting a setting of the camera 120 to preset setting corresponding to the state of the object, and may inspect the object using the image.

For example, an object may be disposed on the stage 110.

For example, the laser 140 may irradiate the object with light to weld the object. For example, the laser 140 may include a light source 141 that outputs light and a scanner 142 that adjusts the path of the light.

For example, the scanner 142 may include at least one galvanometer. Each of the at least one galvanometer may reflect light in a preset axial direction. Each of the at least one galvanometer may reflect light in a different axial direction.

For example, the camera 120 may obtain an image of the object disposed on the stage 110. For example, the camera 120 may be referred to as a vision camera.

For example, the input section 102 may receive an input of the status of the object.

For example, the controller 130 may check the status of the welding object. For example, the controller 130 may determine the status of the object using an image obtained via the camera 120. For example, the controller 130 may compare the obtained image to a base image to determine the condition of the object. For example, the controller 130 may determine the state of the object based on the state of the object input via the input section 102.

In an embodiment, the state of the object may include a state prior to welding being performed using the laser 140. Further, the state of the object may further include a state in which welding is in progress using the laser 140. Further, the state of the object may further include a state in which welding is complete using the laser 140.

For example, the state of the object may include a state prior to welding being performed using the laser 140, a state during which welding is performed using the laser 140, and a state after welding is complete using the laser 140.

For example, the controller 130 may control the camera 120 to adjust a setting value of the camera 120 corresponding to a condition of the object to a preset setting value of the camera 120. For example, the preset setting includes any one or a combination of a preset exposure value, a preset frame per second, a preset sensitivity value based on the international organization for standardization, and a preset field of view.

In an embodiment, the controller 130 may adjust a shooting area of the camera 120 to a preset shooting area of the camera 120 corresponding to the state in which welding is in progress when the state of the object is a state in which welding is in progress. Further, the area of the preset shooting area corresponding to the state in which welding is in progress is smaller than an area of the camera's preset shooting area corresponding to the state prior to welding being performed.

For example, the controller 130 may adjust the shooting area of the camera 120 from a preset first shooting area of the camera 120 corresponding to a state prior to welding being performed to a preset second shooting area of the camera 120 corresponding to a state during welding when the state of the welded object is in a state of welding being performed. For example, the area of the preset second shooting area may be smaller than the area of the preset first shooting area.

In an embodiment, the controller 130 may adjust a shooting area of the camera 120 to a preset shooting area of the camera corresponding to the state in which welding is complete when the state of the object is a state in which welding is complete. Further, the area of the preset shooting area corresponding to the state in which welding is complete is larger than an area of the camera's preset shooting area corresponding to the state in which welding is in progress.

For example, the controller 130 may adjust the shooting area of the camera 120 from a preset second shooting area of the camera corresponding to a state of welding being performed to a preset third shooting area of the camera corresponding to a state of welding being performed when the state of the object to be welded is a state of welding being performed. For example, the area of the preset third shooting area may be larger than the area of the preset second shooting area. For example, the first and third shooting areas may be the same as each other.

Hereinafter, the operation of the welding apparatus 101 will be described when the state of the object is a state prior to welding being performed.

For example, the controller 130 may determine that the state of the object is a state prior to the welding being performed. For example, the controller 130 may use an image obtained by the camera 120 to determine that the state of the object is a state prior to the welding being performed. For example, the controller 130 may determine that the state of the object is a state prior to the welding being performed, based on a state of the object input via the input section 102.

For example, the controller 130 may control the camera 120 to adjust a setting of the camera 120 to a preset setting corresponding to the state prior to the welding being performed.

For example, the camera 120 may obtain an image with the preset setting corresponding to the state prior to the welding being performed.

In an embodiment, the controller 130 may determine a welding path of the laser 140 using the image obtained with the preset setting corresponding to the state prior to welding being performed when the state is a state prior to welding being performed. Further, the controller 130 may control the laser to move along the welding path.

For example, the controller 130 may use the image to determine a welding path for the laser 140. For example, the operation of determining the welding path of the laser 140 may be referred to as auto position alignment.

The following describes the operation of the welding apparatus 101 when the state of the object to be welded is in the state of welding being performed.

For example, the controller 130 may determine that the state of the object is the state of welding being performed. For example, the controller 130 may determine that the state of the object is in a state of welding being performed using images obtained by the camera 120. For example, the controller 130 may determine that the state of the object is a state of welding being performed based on a state of the object input via the input section 102.

For example, the controller 130 may control the camera 120 to adjust a setting of the camera 120 to a preset setting corresponding to the state of welding being performed.

For example, the camera 120 may obtain an image at the preset setting corresponding to the state welding being performed.

For example, the controller 130 may control the laser 140 to move the laser 140 along a determined welding path. More specifically, for example, the controller 130 may control the scanner 142 such that light output from the light source 141 moves along the welding path of the laser 140 and irradiated onto the object.

For example, the controller 130 may use the image to inspect the object being welded.

For example, the controller 130 may inspect whether the laser 140 is being moved along a determined weld path.

For example, the controller 130 may inspect the depth of penetration of the welding, the length of the cosmetic fusion zone, and/or the depth of the bead central bone. However, this is an example, and examples of inspections that the controller 130 may perform on the object may not be limited to this.

For example, the output section 150 may output a result of the inspection of the object.

In the following, operation of the welding apparatus 101 will be described when the state of the object is in a state in which welding is complete.

For example, the controller 130 may determine that the state of the object is such that the weld is complete. For example, the controller 130 may use an image obtained by the camera 120 to determine that the state of the object is in a state in which the welding is complete. For example, the controller 130 may determine that the state of the welded object is a state in which the weld is complete based on a state of the object input via the input section 102.

For example, the controller 130 may control the camera 120 to adjust a setting of the camera 120 to a preset setting corresponding to the state of welding is complete.

For example, the camera 120 may obtain an image at the preset setting corresponding to the welded state.

For example, the controller 130 may use the images to inspect the object when the welding is complete. For example, the controller 130 may inspect the bead position, voids, and/or bead width of the welded object. However, this is an example, and examples of inspections that the controller 130 may perform on the object may be non-limiting.

For example, the output section 150 may output the results of the inspection of the weld object.

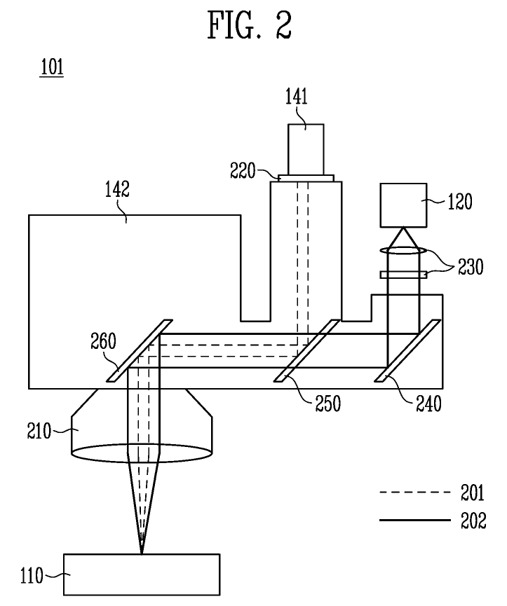

FIG. 2 is a diagram illustrating a welding apparatus according to the present disclosure.

Referring to FIG. 2, a welding apparatus 101 according to the present disclosure may include a camera 120 for photographing a stage 110 on which an object is disposed and a laser 140 for welding the object.

In an embodiment, the laser 140 may include a light source 141 to output the light and a scanner 142 to adjust the path of the light. Further, the controller 130 may control the scanner 142 so that the light output from the light source 141 moves along the welding path and is irradiated onto the object.

For example, the laser 140 may include a light source 141 that outputs light 201 that is irradiated onto the object to be welded and a scanner 142 that determines the path of the light 201. For example, the scanner 142 may include at least one galvanometer 260. The at least one galvanometer 260 can regulate the path of the light 201. Each of the at least one galvanometer 260 may reflect light in a preset axial direction. Each of the at least one galvanometer 260 may reflect light in a different axial direction.

For example, the welding apparatus 101 may further comprise a collimator 220.

For example, the welding apparatus 101 may further comprise a tube lens 230. The tube lens 230 may adjust the focal length of the light 202 and the path of the light 202. The tube lens 230 may be attached to the camera 120.

In an embodiment, the welding apparatus may further comprise a plurality of reflective members 240, 250 for directing the light output from the light source 141 and reflected light reflected from the object to the scanner 142.

For example, the welding apparatus 101 can include a plurality of reflective members 240, 250 that can adjust the path of the light. For example, the plurality of reflective members 240, 250 may reflect light of a particular wavelength and transmit light of a wavelength different from the particular wavelength. For example, the plurality of reflective members 240, 250 may be referred to as dichroic mirrors.

For example, the first reflective member 250 may reflect light output from the light source 141 and transmit reflected light reflected from the object.

For example, the second reflective member 240 can reflect the reflected light 202 transmitted through the first reflective member 250.

For example, the welding apparatus 101 may further comprise a light concentrating lens 210. For example, the light concentrating lens 210 may be referred to as an f-theta lens.

For example, the light 201 output from the light source 141 may be reflected through the first reflective member 250, reflected through the at least one galvanometer 260, and irradiated through the light concentrating lens 210 onto an object disposed on the stage 110.

For example, the reflected light 202 from the object disposed on the stage 110 may be reflected through the focusing lens 210, reflected through the at least one galvanometer 260, transmitted through the first reflective member 250, transmitted through the first reflective member 250, reflected through the second reflective member 240, and incident on the camera 120.

In an embodiment, the optical axis of the light 201 irradiated from the laser 140 onto the object and the optical axis of the reflected light 202 incident on the camera 120 may be coaxial.

For example, the optical axis of the light 201 irradiating the object from the laser 140 and the optical axis of the reflected light 202 reflected from the object and incident on the camera 120 may be coaxial.

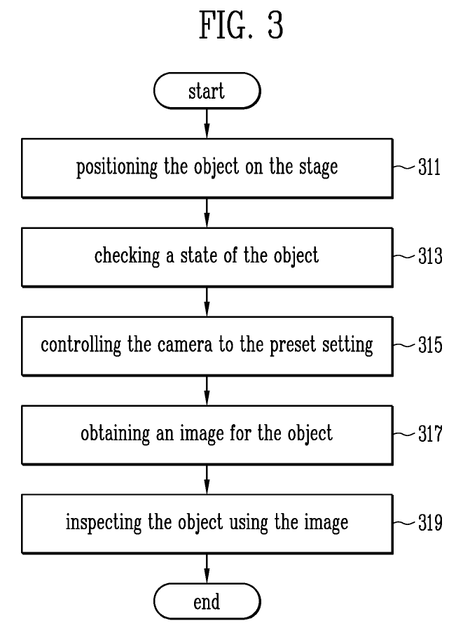

FIG. 3 is a flow diagram illustrating a method for inspecting an object using a welding apparatus according to the present disclosure.

In an embodiment, a method of operation of a welding apparatus 101, including a stage on which an object to be welded is positioned, a laser for irradiating light onto the object to weld, and a camera for obtaining an image of the object, may comprise a step 311 of positioning the object on the stage, a step 313 of checking a state of the object, a step 315 of controlling the camera to the preset setting corresponding to the state of the object, a step 317 of obtaining an image for the object using the camera, and a step 319 of inspecting the object using the image.

For example, referring to FIG. 3, a method of operating a welding apparatus 101 according to the present disclosure may include a step 311 of positioning an object to be welded on a stage 110.

The method of operation of the welding apparatus 101 according to the present disclosure may include a step 313 of checking the state of the object. For example, the state of the object to be welded may represent a state prior to welding being performed using the laser 140, a state during welding using the laser 140, and a state after welding is complete using the laser 140.

The method of operating the welding apparatus 101 according to the present disclosure may include the step of determining a state of the welded object using an image obtained via the camera 120. For example, the method of operation of the welding apparatus 101 according to the present disclosure may include the step of comparing the obtained image with a base image to determine the state of the welded object.

The method of operating the welding apparatus 101 according to the present disclosure may also include the step of determining a state of the object based on a state of the object inputted via the input section 102.

The method of operating the welding apparatus 101 according to the present disclosure may include a step 315 of adjusting the camera 120 to a preset setting of the camera 120 corresponding to the state of the welding object. For example, the preset settings may include any one of a preset exposure value, a preset frame per second value, a preset sensitivity value based on international organization for standardization, and a preset field of view, or a combination thereof.

A method of operating the welding apparatus 101 according to the present disclosure may include a step 317 of obtaining an image of the object to be welded, via the camera 120.

The method of operating the welding apparatus 101 according to the present disclosure may include a step 319 of inspecting the welding object using the image. For example, the step of inspecting the object may include determining a weld path of the object and identifying defects in the object. More details on the steps of inspecting the weldment will be described later.

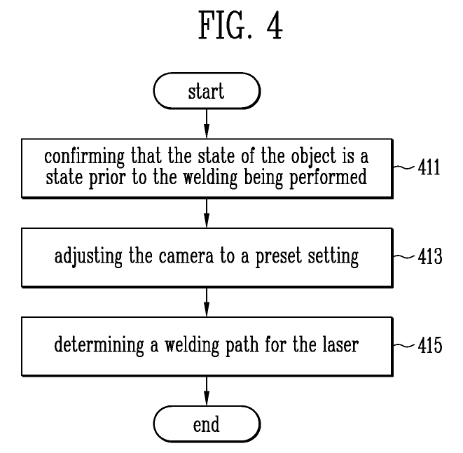

FIG. 4 is a flow diagram illustrating a method for determining a welding path when a state of an object according to the present disclosure is a state prior to welding being performed.

Referring to FIG. 4, a method of operating the welding apparatus 101 according to the present disclosure may include a step 411 of confirming that the state of the object to be welded is a state prior to the welding being performed.

The method of operation of the welding apparatus 101 according to the present disclosure may include the step of determining, based on comparing an image of the welded object obtained using the camera 120 with a base image, that the state of the object is a state prior to the welding being performed.

Alternatively, the method of operating the welding apparatus 101 according to the present disclosure may comprise the step of confirming, via the input section 102, that the state of the object is a state prior to the welding being performed.

The method of operating the welding apparatus 101 according to the present disclosure may include the step 413 of adjusting the camera 120 to a preset setting corresponding to the state prior to the welding being performed.

For example, the preset settings may include 20 frames per second, a 40000 us exposure value, and/or a 3072 sensitivity value based on international organization for standardization.

For example, the preset settings may include a preset field of view for obtaining an image comprising the overall geometry of the welding object.

For example, the method of operating the welding apparatus 101 may include a step 415 of determining a welding path for the laser 140 based on the images obtained using the camera 120 adjusted to the preset settings.

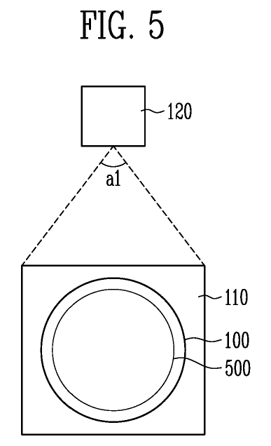

FIG. 5 is a diagram illustrating a method for determining a welding path when a state of an object according to the present disclosure is a state prior to welding being performed.

More specifically, FIG. 5 is a diagram illustrating a portion of a welding apparatus 101 and an object 100 disposed on a stage 110 when the state of the object 100 is in a state of welding being performed.

For example, the welding object 100 may be positioned on the stage 110.

For example, the settings of the camera 120 may be adjusted to a preset setting corresponding to state of the object 100.

For example, the preset settings may include a preset field of view a1 over which images may be obtained that include the entirety of the object 100. For example, an image obtained in the preset field of view a1 may have a resolution of 2560x1916. The preset settings may include, for example, 20 frames per second, a 40000 us exposure value, and/or a 3072 ISO (international organization for standardization) value. However, this is an example, and the numerical values of the preset settings may be non-limiting.

For example, a welding path 500 of the laser 140 to the object 100 may be determined based on images obtained using the camera 120 adjusted to the preset settings. For example, the controller 130 may use the image to determine positional information (e.g., coordinates) of the object 100. Based on the location information of the object 100, the controller 130 may determine the weld path 500.

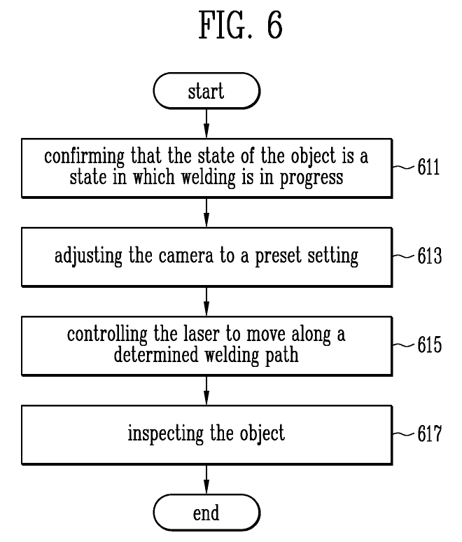

FIG. 6 is a flow diagram illustrating a method for performing a welding when a state of an object according to the present disclosure is a state in which welding is in progress.

For example, referring to FIG. 6, a method of operating the welding apparatus 101 according to the present disclosure may include a step 611 of confirming that the state of the object is a state in which welding is in progress.

The method of operation of the welding apparatus 101 according to the present disclosure may include a step 613 of adjusting the camera 120 to a preset setting corresponding to the state in which welding is in progress.

The method of operating the welding apparatus 101 according to the present disclosure may include the step 615 of controlling the laser 140 to move along a determined welding path with respect to the object to be welded. Specifically, the method of operating the welding apparatus 101 according to the present disclosure may include the step of controlling the scanner 142 such that light output by to the light source 141 moves along the determined welding path and irradiated onto the object.

The method of operating the welding apparatus 101 according to the present disclosure may include the step 617 of inspecting the object. For example, the method of operating the welding apparatus 101 according to the present disclosure may include the step of inspecting the object, using an image obtained through the camera 120 adjusted to a preset setting corresponding to a state in which welding is in progress.

For example, the step of inspecting the object may include determining whether the laser 140 moves along a determined weld path.

For example, inspecting the weld object may include inspecting the weld depth, the cosmetic fusion length, and/or the bead central bone depth of the weld object. However, this is an example, and examples of the kinds of inspections that may be included in the step of inspecting the weldment may be non-limiting.

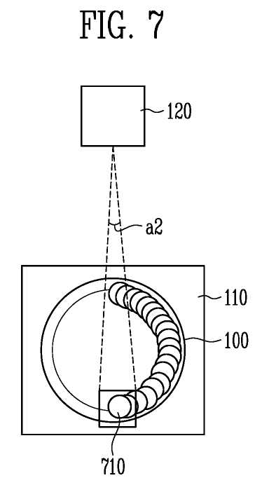

FIG. 7 is a diagram illustrating a method for performing a welding when a state of an object according to the present disclosure is a state in which welding is in progress.

More specifically, FIG. 7 is a drawing illustrating a portion of a welding apparatus 101 and an object 100 positioned on a stage 110 when the state of the object 100 is in a state in which welding is in progress.

For example, the welding object 100 may be disposed on the stage 110.

For example, the camera 120 may be adjusted to a preset setting corresponding to a state during welding of the object 100.

For example, the preset settings may include a preset field of view a2 over which an image may be obtained that includes a portion 710 of the welded object 100 in which welding is in progress. For example, an image obtained in the preset field of view a2 may have a resolution of 256x256. The preset settings may include, for example, 5000 frames per second, a 90 us exposure value, and/or a 1024 ISO value. However, this is an example, and the numerical values of the preset settings may be non-limiting.

For example, an inspection of the object 100 may be performed based on images obtained using the camera 120 adjusted to the preset settings.

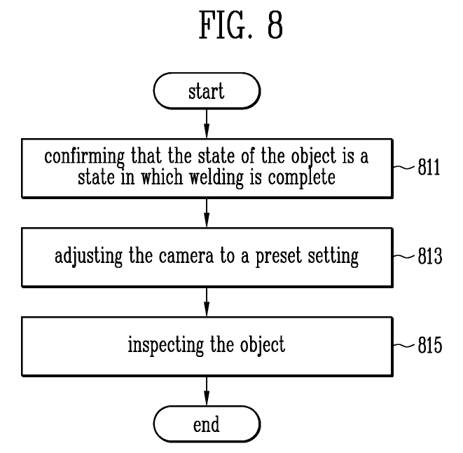

FIG. 8 is a flow diagram illustrating a method for inspecting an object when a state of an object according to the present disclosure is a state in which welding is completed.

Referring to FIG. 8, a method of operating the welding apparatus 101 according to the present disclosure may include a step 811 of confirming that the state of the object 100 is a state in which welding is complete.

The method of operation of the welding apparatus 101 according to the present disclosure may include a step 813 of adjusting the camera 120 to a preset setting corresponding to the state in which the welding is complete.

The method of operating the welding apparatus 101 according to the present disclosure may include a step 815 of inspecting the welded object based on an image obtained by the camera 120 adjusted to the preset setting.

For example, inspecting the object may include inspecting the welded object for bead position, voids, and/or bead width. However, this is an example, and examples of the kinds of inspections that may be included in the step of inspecting a weldment may be limited.

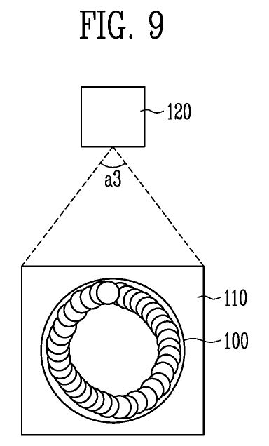

FIG. 9 is a diagram illustrate a method for inspecting an object when a state of an object according to the present disclosure is a state in which welding is complete.

More specifically, FIG. 9 is a drawing illustrating a portion of a welding apparatus 101 and an object 100 disposed on a stage 110 when the state of the object 100 is a state in which welding is complete.

For example, the object 100 may be disposed on the stage 110.

For example, the camera 120 may be adjusted to a preset setting that corresponds to a completely welded state of the object 100.

For example, the preset settings may include a preset field of view a3 in which an image may be obtained that includes the entirety of the welded object 100. For example, an image obtained in the preset field of view a3 may have a resolution of 2560x1916. The preset settings may include, for example, 20 frames per second), a 50000 us exposure value, and/or a 4096 ISO value. However, this is an example, and the numerical values of the preset settings may be non-limiting.

For example, the welded object 100 may be inspected for defects based on images obtained by the camera 120 adjusted to the preset settings.

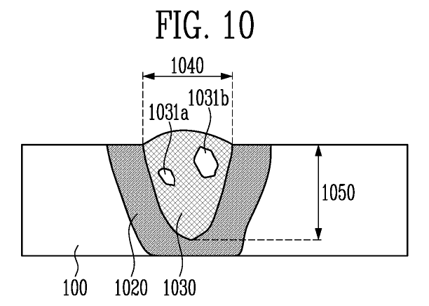

FIG. 10 is a diagram illustrating how a welding apparatus according to the present disclosure inspects an object.

More specifically, FIG. 10 is a diagram illustrating a cross-sectional view of an object 100 when the welding is complete.

For example, the weldable object 100 may form a heat affected zone HAZ 1020 and a welding bead 1030 as a result of welding.

For example, the welding bead 1030 may represent the area where the welding was performed. For example, the heat affected zone 1020 may represent an area where the physical and/or chemical properties of the welded object 100 have changed due to heat generated during the welding process.

In an embodiment, the controller 130 may use the image obtained with the preset setting corresponding to the state in which welding is completed to inspect whether the object is defective when the state of the object is the state in which welding is completed.

For example, the controller 130 may determine a bead width 1040 of the object 100 when the state of the object 100 is in a completed welded state. For example, the controller 130 may determine that the object 100 is free of defects if the bead width 1040 is found to be within a range of specified length. For example, the controller 130 may determine that the object 100 is defective if the bead width 1040 is determined not to fall within the range of specified length.

For example, the controller 130 may check whether the bead position is formed at a predetermined location on the object 100 when the state of the object 100 is the state in which welding is complete. For example, the controller 130 may determine that the object 100 is defective if it is determined that the bead position has not been formed at the predetermined position on the object 100.

For example, the controller 130 may determine the size, number, and/or depth of the voids 1031a, 1031b created in the object 100 when the state of the object 100 is the state in which welding is complete. For example, the voids 1031a, 1031b may represent areas in the object 100 that have solidified and formed an air layer in the object 100 due to absorption of hydrogen and/or instability of the melt pool during the welding process. For example, the controller 130 may determine that the object 100 is free of defects if the size, number, and/or depth of the voids 1031a, 1031b are found to be within a specified range of size, number, and/or depth. For example, the controller 130 may determine that the object 100 is defective if the size, number, and/or depth of the voids 1031a, 1031b is determined to be not within the specified range of size, number, and/or depth.

For example, the controller 130 may determine a welding depth 1050 of the object 100 when the object 100 is in a state of welding being performed. For example, the welding depth 1050 may indicate the depth to which the weld bead has penetrated the object 100. For example, the controller 130 may determine that the object 100 is free of defects if the welding depth 1050 is found to be within a specified depth range. For example, the controller 130 may determine that the object 100 is defective if the welding depth 1050 is determined not to be within the specified depth range. For example, the operation of measuring and inspecting the welding depth 1050 may be referred to as lack of fusion and penetration or excessive penetration.

For example, the controller 130 may inspect for grooves when the object 100 is in a state of welding being performed. The groove may indicate a groove formed in the portion of the object 100 to be welded to allow the weld to be performed.

For example, the controller 130 may inspect for a linear misalignment when the state of the object 100 is in a state of welding being performed. A linear misalignment may indicate a condition in which the object 100 and the material to be welded are out of alignment with each other.

The scope of the present disclosure is indicated by the following claims rather than by the detailed description above, and all modifications or variations derived from the meaning and scope of the claims and their equivalents are to be construed as being within the scope of the present disclosure.

What is claimed is:

1. A welding apparatus comprising:
a stage on which an object to be welded is positioned;
a laser for irradiating light onto the object to weld;
a camera for obtaining an image of the object; and
a controller for controlling the camera;
wherein the controller checks a state of the object, controls the camera to obtain the image by adjusting a setting of the camera to preset setting corresponding to the state of the object, and inspects the object using the image.

2. The welding apparatus according to the claim 1, wherein the preset setting includes any one or a combination of a preset exposure value, a preset frame per second, a preset sensitivity value based on the international organization for standardization, and a preset field of view.

3. The welding apparatus according to the claim 1, wherein the state of the object includes a state prior to welding being performed using the laser.

4. The welding apparatus according to the claim 3, wherein the controller determines a welding path of the laser using the image obtained with the preset setting corresponding to the state prior to welding being performed when the state is a state prior to welding being performed, and controls the laser to move along the welding path.

5. The welding apparatus according to the claim 1, wherein the laser includes a light source to output the light and a scanner to adjust the path of the light.

6. The welding apparatus according to the claim 5, wherein the controller controls the scanner so that the light output from the light source moves along the welding path and is irradiated onto the object.

7. The welding apparatus according to the claim 5, further comprising:
a plurality of reflective members for directing the light output from the light source and reflected light reflected from the object to the scanner.

8. The welding apparatus according to the claim 7, wherein the plurality of reflective members include:
a first reflective member for reflecting the light output from the light source and transmitting the reflected light, and
a second reflective member for reflecting the reflected light transmitted through the first reflective member.

9. The welding apparatus according to the claim 1, wherein the optical axis of the light irradiated from the laser onto the object and the optical axis of the reflected light incident on the camera are coaxial.

10. The welding apparatus according to the claim 3, wherein the state of the object further includes a state in which welding is in progress using the laser.

11. The welding apparatus according to the claim 10, wherein the controller adjusts a shooting area of the camera to a preset shooting area of the camera corresponding to the state in which welding is in progress when the state of the object is a state in which welding is in progress, and the area of the preset shooting area corresponding to the state in which welding is in progress is smaller than an area of the camera's preset shooting area corresponding to the state prior to welding being performed.

12. The welding apparatus according to the claim 10, wherein the state of the object further includes a state in which welding is complete using the laser.

13. The welding apparatus according to the claim 12, wherein the controller adjusts a shooting area of the camera to a preset shooting area of the camera corresponding to the state in which welding is complete when the state of the object is a state in which welding is complete, and the area of the preset shooting area corresponding to the state in which welding is complete is larger than an area of the camera's preset shooting area corresponding to the state in which welding is in progress.

14. The welding apparatus according to the claim 12, wherein the controller uses the image obtained with the preset setting corresponding to the state in which welding is complete to inspect whether the object is defective when the state of the object is the state in which welding is complete.

15. A method of operation of a welding apparatus, including a stage on which an object to be welded is positioned, a laser for irradiating light onto the object to weld, and a camera for obtaining an image of the object, comprising:
a step of positioning the object on the stage;
a step of checking a state of the object;
a step of controlling the camera to the preset setting corresponding to the state of the object;
a step of obtaining an image for the object using the camera; and
a step of inspecting the object using the image.
